(19) United States
(12) Patent Application Publication
(10) Pub. No.: US 2023/0232105 A1
(43) Pub. Date: Jul. 20, 2023

(54) Alignment of User's Field of View With Head-Mounted Camera and/or Light

(71) Applicant: Bernard A. Hausen, Redwood City, CA (US)

(72) Inventor: Bernard A. Hausen, Redwood City, CA (US)

(21) Appl. No.: 18/083,072

(22) Filed: Dec. 16, 2022

Related U.S. Application Data
(60) Provisional application No. 63/292,537, filed on Dec. 22, 2021.

(51) Int. Cl. H04N 23/69; G06F 3/16; G02B 27/01; H04N 23/695; G03B 17/56; F16M 11/12; F16M 11/18; F16M 13/04

(52) U.S. Cl. CPC H04N 23/69; G06F 3/167; G02B 27/0176; H04N 23/695; G03B 17/561; F16M 11/123; F16M 11/18; F16M 13/04; G02B 2027/0138; G02B 27/0172; G02B 2027/0198; G02B 2027/0159; H04N 23/56

(57) ABSTRACT

A method for aligning the field of view of a user with the field of view of a camera mounted on the user's head may include providing at least one head-mounted camera module that includes at least one sensor that in turn includes an image sensor, where the said image sensor outputs video of an area; receiving a first input from a user to expect a second input relating to the field of view; receiving the second input relating to the field of view; and aligning the field of view of the user with the field of view of the camera.

### FIELD OF THE INVENTION

The invention generally relates to head-mounted cameras, and more particularly to the alignment of the field of view of a head-mounted camera with the user's view, and/or with a head-mounted light.

### BACKGROUND

The use of endoscopes or other cameras insertable into the body is necessary for some types of minimally-invasive (also called endoscopic) surgery. Such minimally-invasive surgery may be performed directly by a surgeon, or may be performed using a surgical robot such as the daVinci® Surgical System of Intuitive Surgical (Sunnyvale, Calif.). An example of the type of minimally-invasive surgery that requires a camera to be inserted into the body to view the surgical site is totally endoscopic coronary artery bypass graft (TECAB) surgery. Whether a surgeon uses tools directly inserted by hand into the thoracic cavity to place the graft, or uses a surgical robot, a camera must view the site of attachment of the graft to the coronary artery or the aorta. The camera outputs video to one or more monitors, allowing the surgeon to view that video and control tools or the surgical robot to properly place and attach the graft. In addition, other healthcare professionals in the vicinity, such as but not limited to anesthesiologists, nurses, medtechs, and vendor representatives, can view the video and remain engaged with the procedure. Thus, even though minimally-invasive surgery is performed through small ports in the patient's body, multiple people in the operating room or other surgical location can easily view the procedure and its progress.

Paradoxically, open surgery is often difficult for anyone other than the surgeon and at most two attending nurses or other professionals to watch. The incisions in the patient may be large. The chest of the patient may be open. However, the surgeon is positioned adjacent to the patient, as is an attending nurse. Their bodies block the view by others. Further, even without the surgeon or attending nurse standing adjacent to the patient, it can be difficult to see the surgical site even a few feet away. Further, the anesthesiologist is typically seated, as are other professionals in the operating room, and their elevation is not high enough to see into the surgical site. As a result, it can be difficult for people other than the surgeon and the attending nurse to remain engaged with the procedure, resulting in less-than-optimal care for the patient.

Cameras are known that mount to the surgical light handle commonly used in operating rooms. However, such cameras typically need to be frequently repositioned in use, which is inconvenient. The surgeon's head or hands often obscure the surgical field. The video quality is often insufficient due to the distance between the camera and the surgical field. Typically, such cameras do not provide audio, either. Large mobile camera systems on wheels/casters are also known, in which cameras are placed on long swivelable arms. Such cameras have the same issues as the light-handle-mounted cameras described above. In addition, such mobile camera systems have a large footprint in a confined operating environment, which can make their use challenging. Further, such devices may fall into the category of capital equipment and typically are expensive, restricting their adoption at hospitals.

A surgeon may wear a head-mounted camera and a head-mounted light during open surgery. The camera must be manually aligned with the surgeon's eyes, so that the camera views what the surgeon views. Conventionally, a nurse or other professional in the OR must perform the alignment, because the camera is not sterile and thus the surgeon cannot touch the camera without contaminating the sterile field. Similarly, alignment of the light with the camera must be performed the same way. Because someone has to perform the alignment for the surgeon, there is no guarantee that the alignment will actually align the camera with the surgeon's view, or the light with the camera's field of view.

Further, in non-surgical applications, there is a need for the ability to align the field of view of a user with the field of view of a head-mounted or body-mounted camera. For example, a skier, runner, cyclist or other athlete may wear a head-mounted or helmet-mounted camera such as the GOPRO® camera of GoPro, Inc. of San Mateo, Calif. The user may wish to use the video obtained with that camera for social media, broadcast media or training purposes, or for other purposes, and accordingly the field of view of the camera should be able to be aligned easily with the field of view of the user. Other non-surgical applications may include teaching, whether to a class in person or to a remote class. For example, an archaeological performing a dig, or a geologist exploring a particular area, may wear a head-mounted camera as described above, and the current manual manner of aligning the camera's field of view with the user's field of view can be cumbersome and distract from the subject matter that the user is attempting to teach.

Thus, there is an unmet need for camera and lighting systems for surgical use as well as non-surgical use that align the user's field of view with that of a head-mounted camera, and/or with a head-mounted light, that does not require manually touching and manipulating the camera.

### SUMMARY OF THE INVENTION

According to some aspects of the invention, a method for aligning the field of view of a user with the field of view of a camera mounted on the user's head may include providing at least one head-mounted camera module that includes at least one sensor that in turn includes an image sensor, where the image sensor outputs video of an area; receiving a first input from a user to expect a second input relating to the field of view; receiving the second input relating to the field of view; and aligning the field of view of the user with the field of view of the camera.

According to some aspects of the invention, a method for aligning the field of view of a user with the field of view of a camera mounted on the user's head may include providing at least one head-mounted camera module that includes at least one sensor that in turn includes an image sensor, where the image sensor outputs video of an area; and at least one motorized gimbal attached to the camera module; receiving a first input from a user to expect a second input relating to the field of view; receiving the second input relating to the field of view; and aligning the field of view of the user with the field of view of the camera.

According to some aspects of the invention, a camera system mountable on the head of a user includes at least one head-mounted light module; a camera module associated with the light module; a motorized gimbal attached to the camera module; and a base to which the motorized gimbal is attached.

According to some aspects of the invention, a light module for a camera mounted on a user's head includes a heat sink including a cavity defined in a distal portion thereof, the cavity including an opening at a proximal end thereof, and a slot defined through a bottom wall thereof, the slot having a distal surface that is substantially planar; and an LED assembly including at least one printed circuit board including at least one LED package, wherein the printed circuit board is slidable into the slot such that the at least one LED package is positioned proximal to the opening at the proximal end of the cavity such that light emitted from the at least one LED package is transmitted through the opening.

According to some aspects of the invention, a head-mounted camera may be aligned with the user's ocular line of sight utilizing software. The head-mounted camera may include a high-resolution sensor, such as a 4K sensor, an 8K sensor, or a sensor with even higher resolution. The head-mounted camera, or a separate sensor associated with the head-mounted camera, may be adapted to sense gestural commands by the user. For example, a user wearing the head-mounted camera may simulate drawing a circle or other shape with a fingertip, fingertips or hand over an area at which the user wishes to look, or is currently looking. Software associated with the head-mounted camera or separate sensor senses that the user has made a specific gesture, and zooms the field of view and then pans and tilts to an area enclosed by or adjacent to the user's gesture. Because the sensor is a high-resolution sensor, the adjustment of the field of view need not be mechanical. Instead, software may digitally move the field of the view of the camera by zooming to, panning and tilting the image, and focusing on the area enclosed by or adjacent to the user's gesture.

According to some aspects of the invention, a head-mounted camera may be aligned with the user's ocular line of sight utilizing hardware. The field of view of the camera may be adjusted by optically zooming the camera, and panning and/or tilting the camera via a motorized gimbal attached to the camera.

According to some aspects of the invention, a head-mounted light may be utilized in conjunction with the head-mounted light. The head-mounted camera may be configured to sense the edges of an area illuminated by the head-mounted light. Software may then digitally move the field of the view of the camera by zooming to, then panning and tilting, the image and focusing on the brightly illuminated area. Alternately, the field of view of the camera is adjusted by optically zooming the camera, and panning and/or tilting the camera via a motorized gimbal attached to the camera.

According to some aspects of the invention, a light module for a camera mounted on a user's head, may include a heat sink that includes a cavity defined in a distal portion thereof, the cavity including an opening at a proximal end thereof, and a slot defined through a bottom wall thereof, the slot having a distal surface that is substantially planar; and an LED assembly including at least one printed circuit board including at least one LED package, where the printed circuit board is slidable into the slot such that the at least one LED package is positioned proximal to the opening at the proximal end of the cavity such that light emitted from the at least one LED package is transmitted through the opening.

### BRIEF DESCRIPTION OF THE DRAWINGS

FIG. 1 is a side view of a camera assembly including a light module and a camera module.

FIG. 2 is a perspective view of the light module and the camera module of

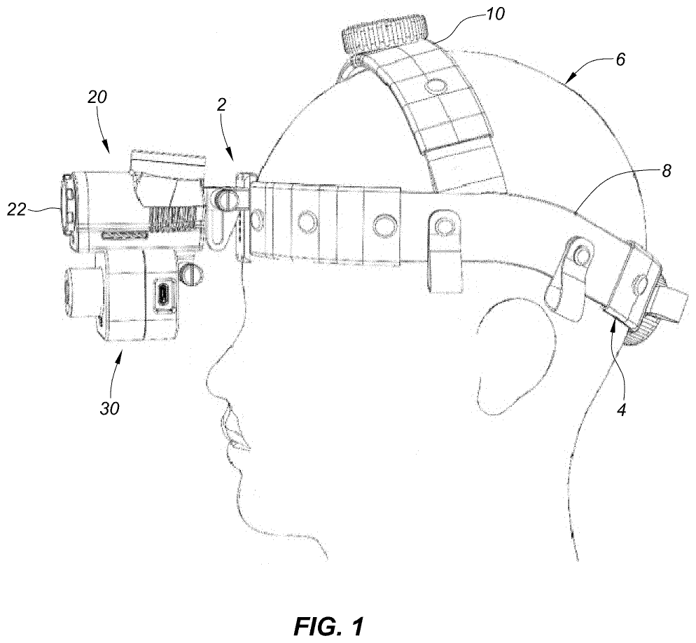

FIG. 1.

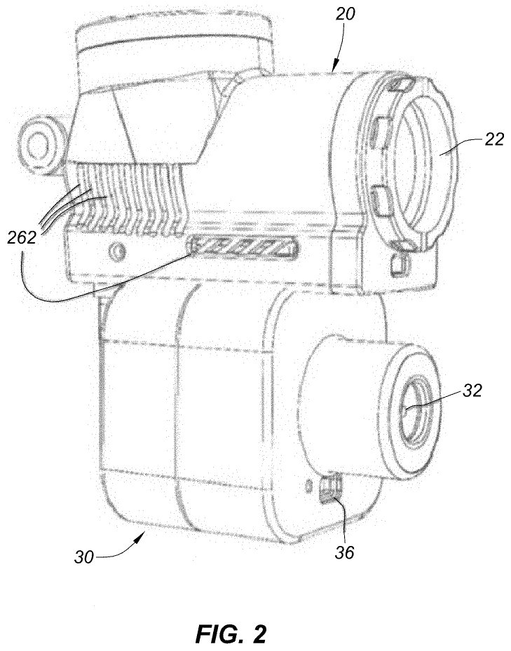

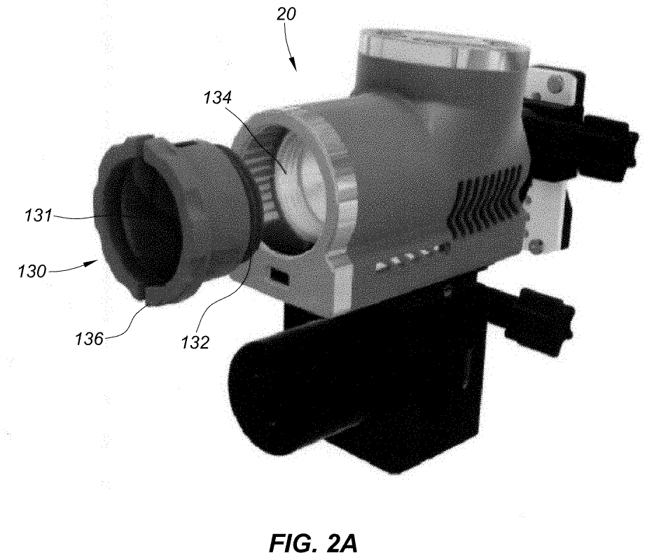

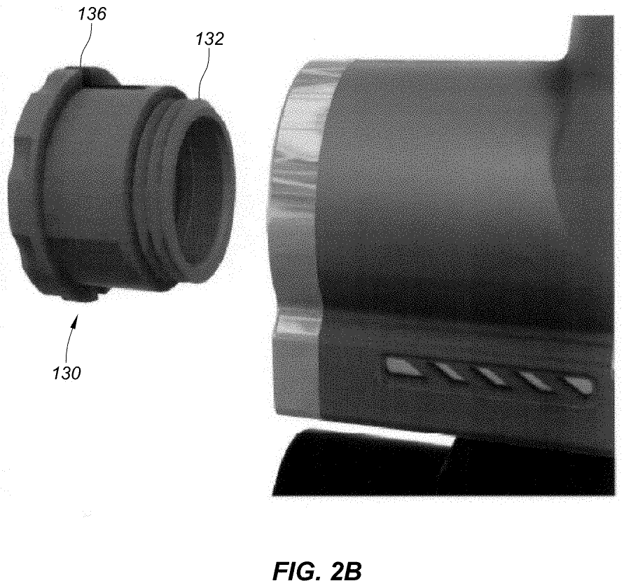

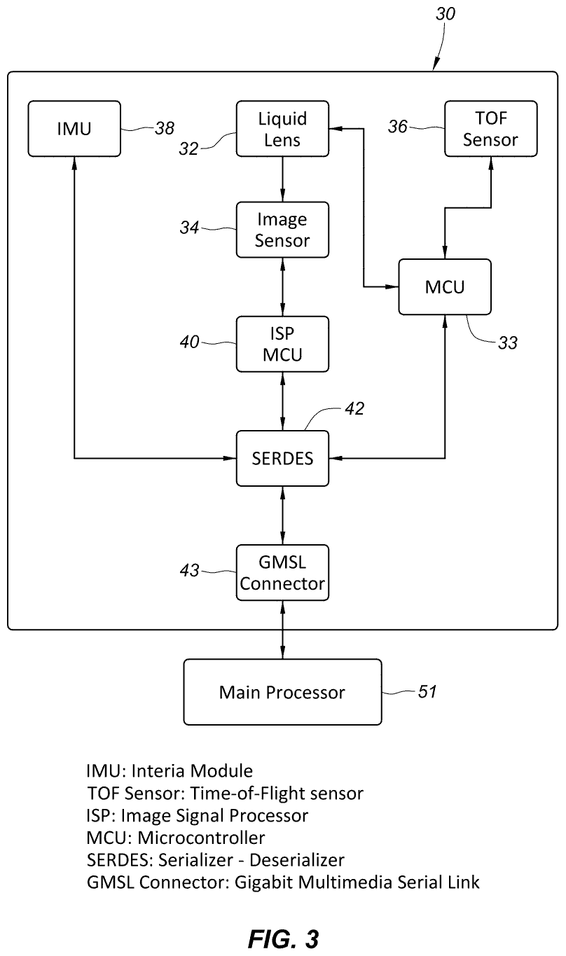

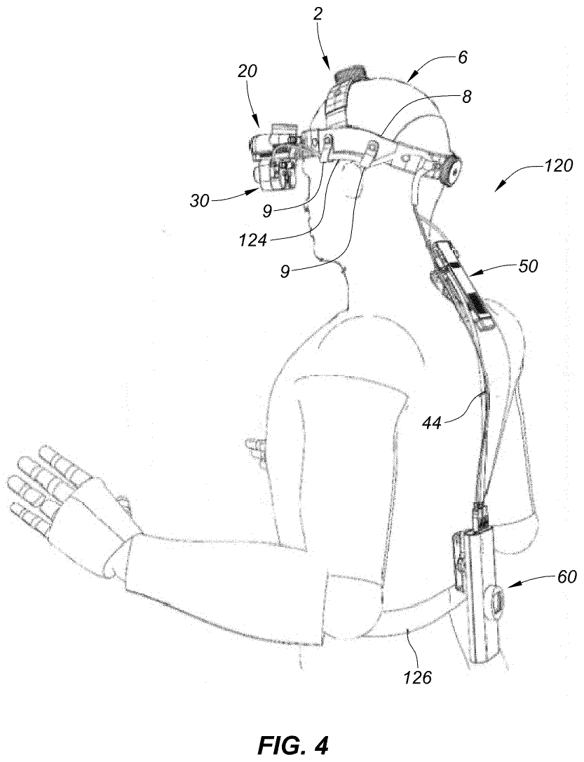

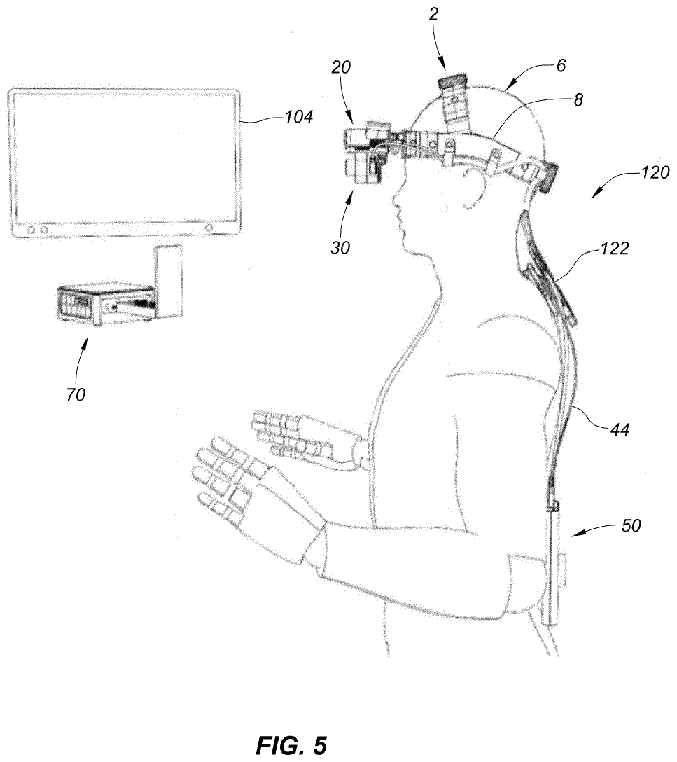

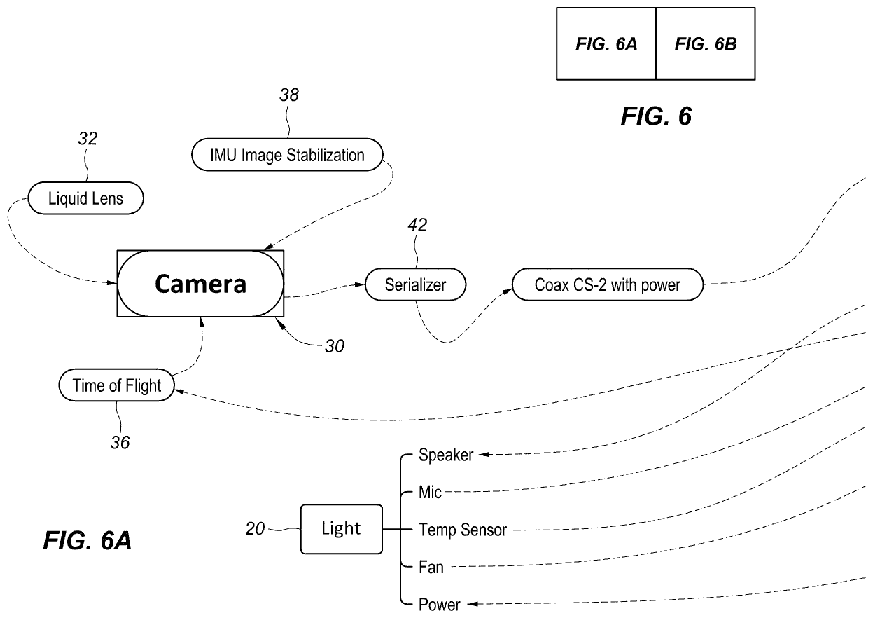

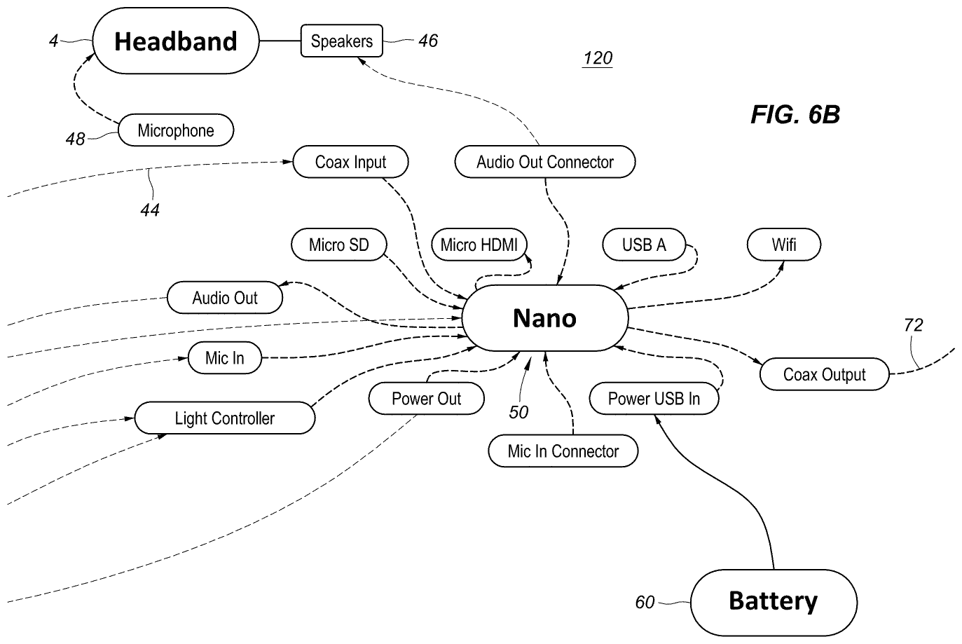

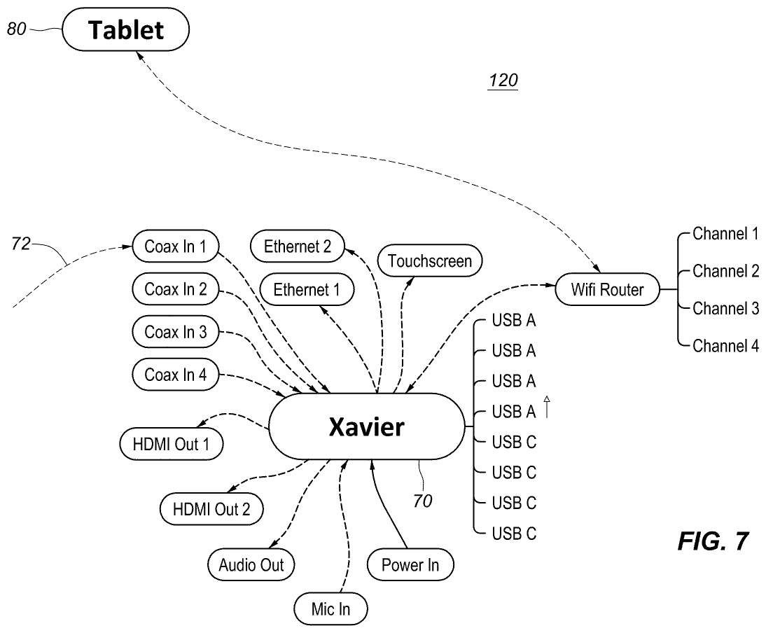

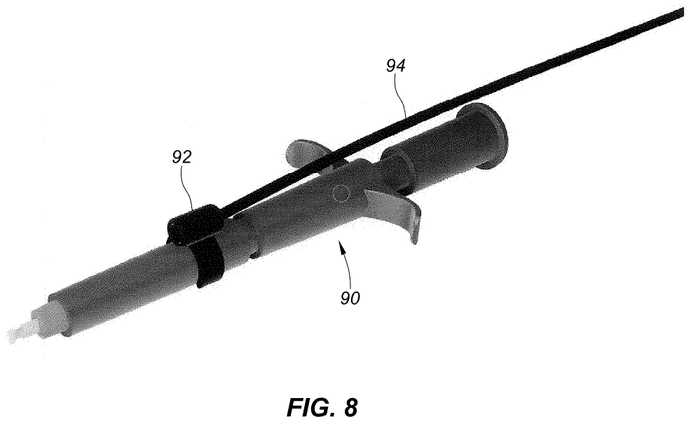

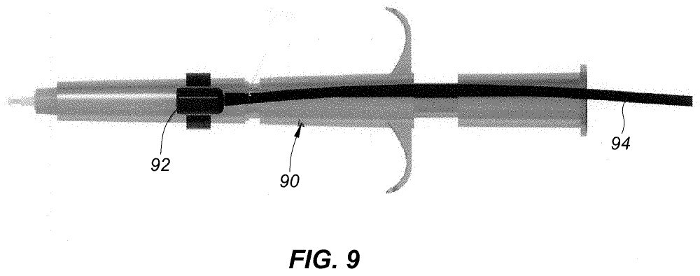

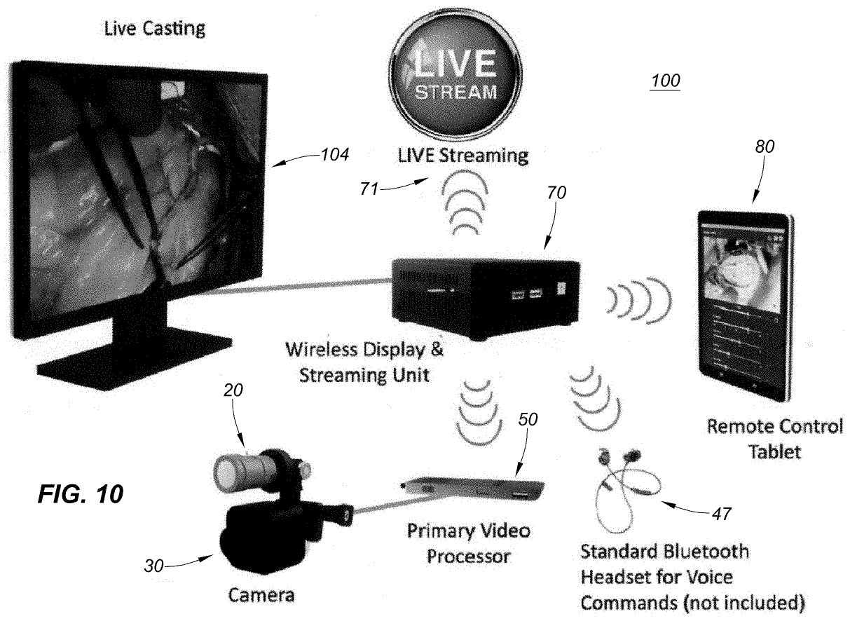

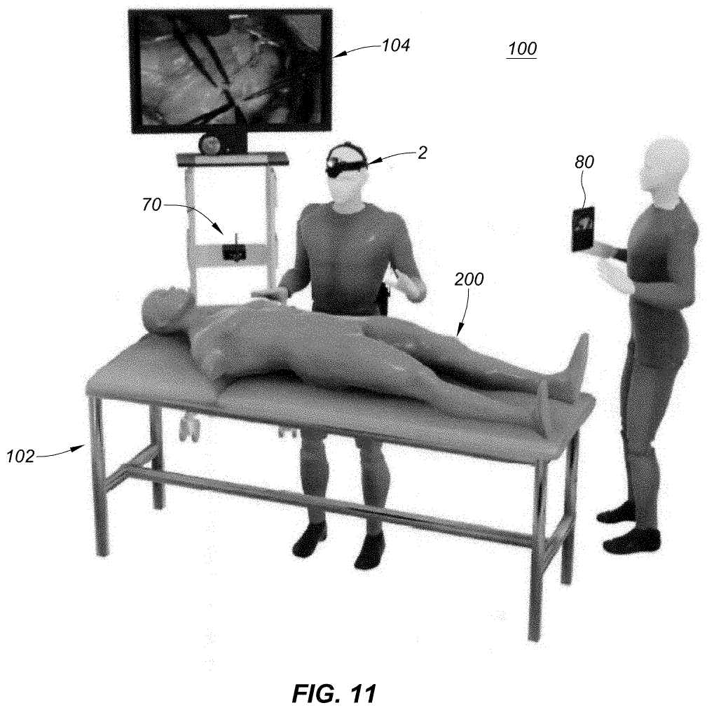

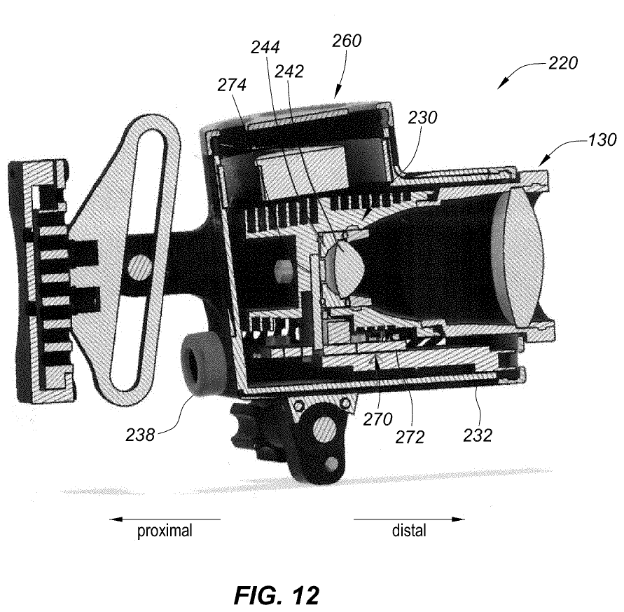

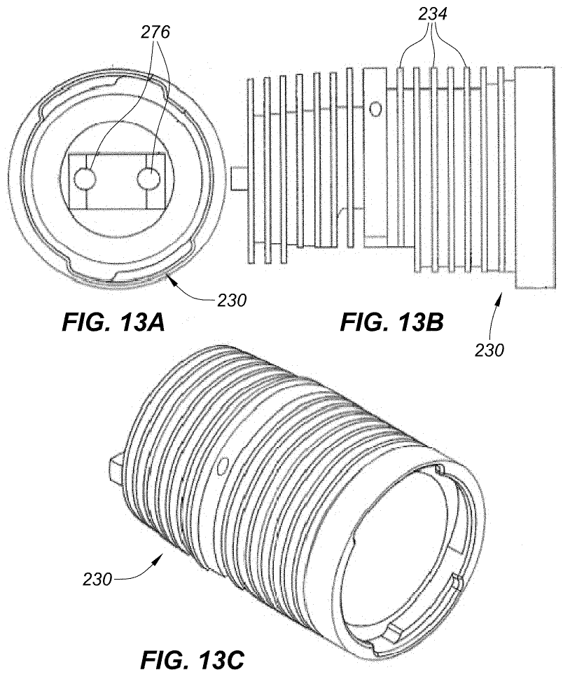

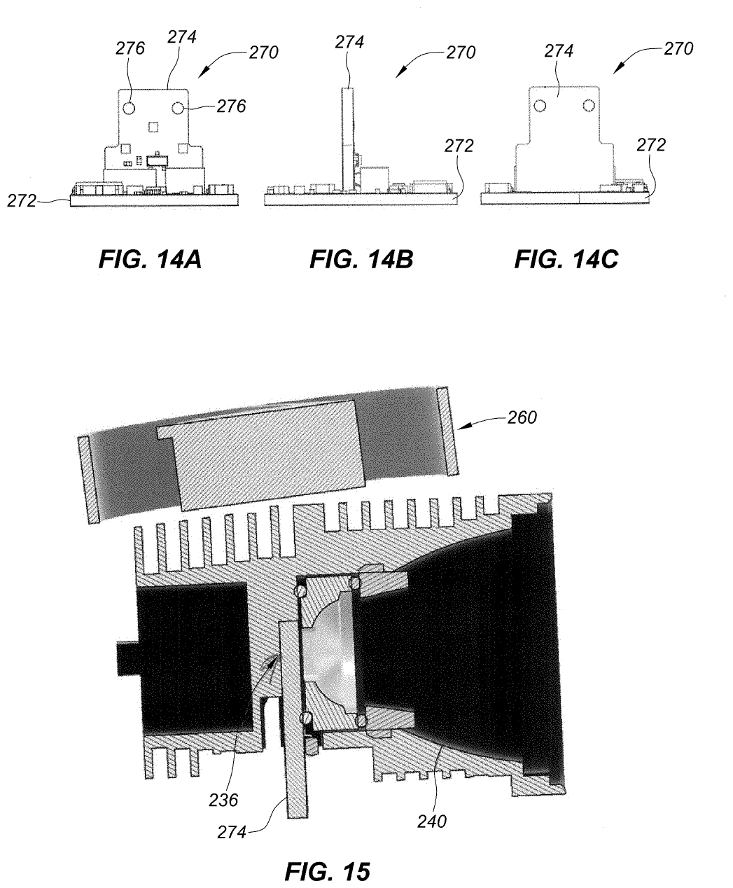

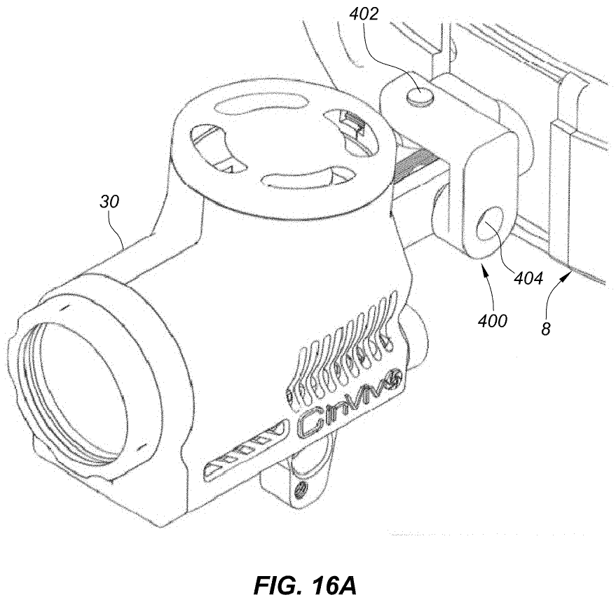

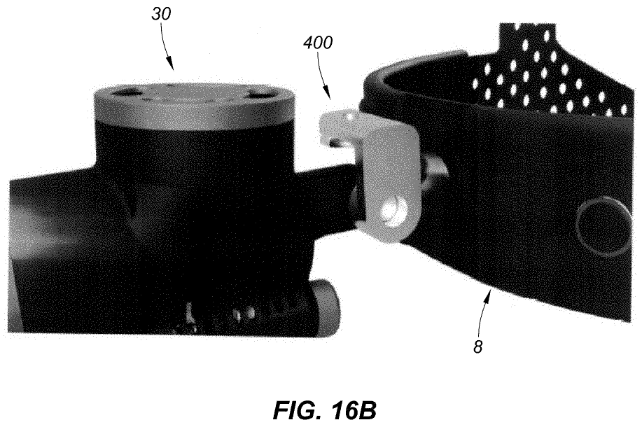

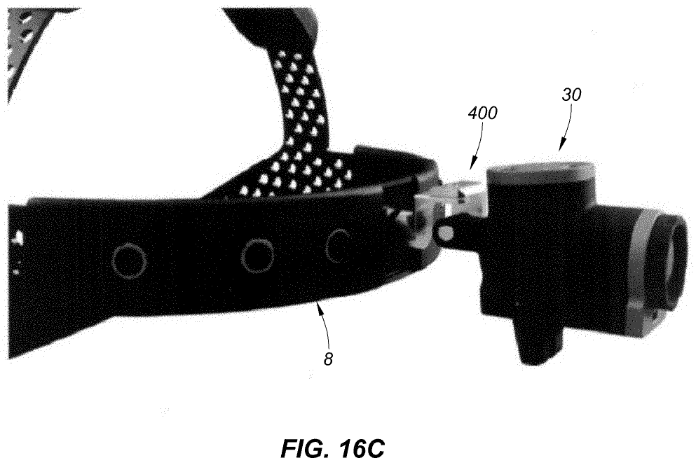

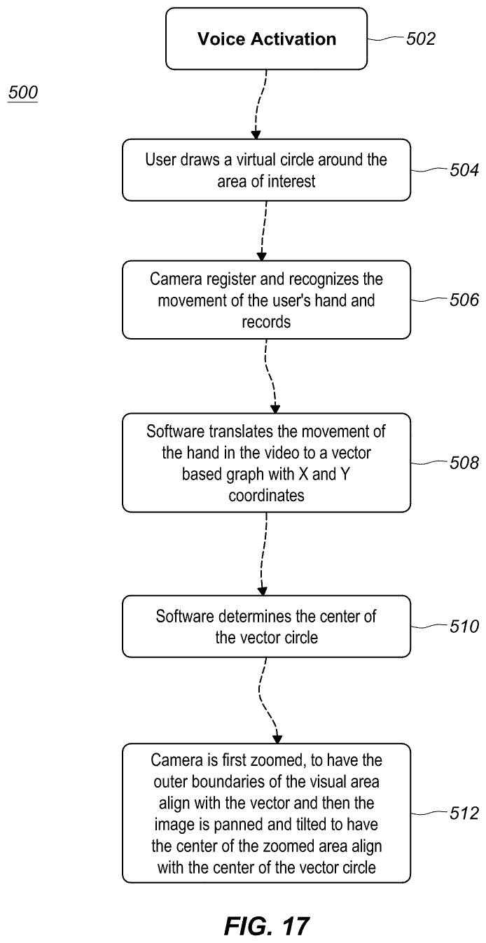

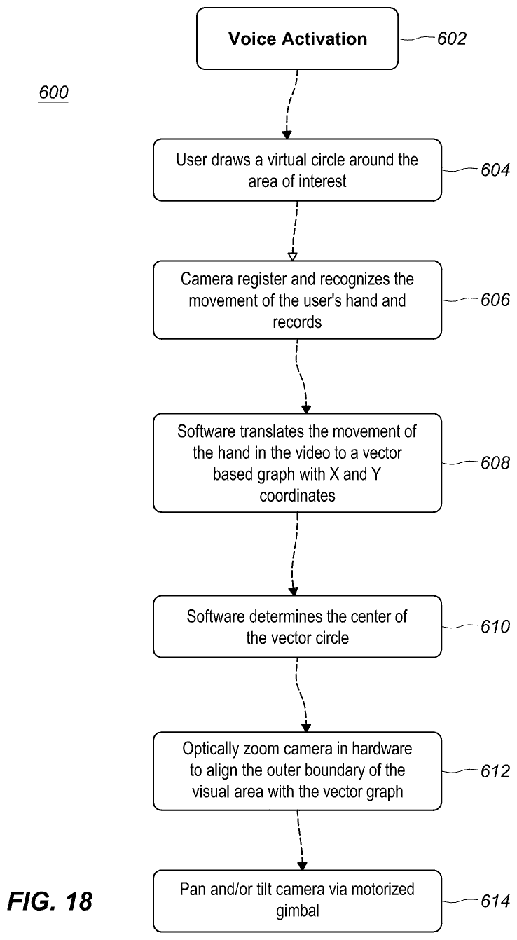

FIG. 2A is a perspective view of a swappable lens and its relationship to the light module of FIGS. 1-2.

FIG. 2B is another perspective view of a swappable lens and its relationship to the light module of FIGS. 1-2.

FIG. 3 is a schematic view of the camera module architecture of FIG. 1.

FIG. 4 is a perspective view of a user wearing the camera assembly of FIG. 1 attached to a headband, a wearable unit , and a battery.

FIG. 5 is a side view of a user wearing the camera assembly of FIG. 1 attached to a headband, a wearable unit, a battery, and additionally showing a base station and monitor.

FIG. 6 shows the arrangement of FIGS. 6A and 6B relative to one another.

FIG. 6A is a first page of a schematic view of a camera assembly of FIG. 1 and a wearable unit.

FIG. 6B is a second page of a schematic view of a camera assembly of FIG. 1 and a wearable unit.

FIG. 7 is a schematic view of a base station with a data connection to the wearable unit of FIG. 3.

FIG. 8 is a perspective view of a camera attached to a surgical tool.

FIG. 9 is a side view of a camera attached to a surgical tool.

FIG. 10 is a schematic view of a location in which the camera assembly of FIG. 1 and the base station of FIGS. 5 and 7 may be utilized.

FIG. 11 is a schematic view of the location of FIG. 10, where that location is an operating room.

FIG. 12 is a cutaway side view of a second exemplary light module.

FIG. 13A is an end view of an exemplary heat sink used in the light module of FIG. 12.

FIG. 13B is a side view of the exemplary heat sink of FIG. 13A.

FIG. 13C is a perspective view of the exemplary heat sink of FIG. 13A.

FIG. 14A is a front view of a circuit board used in the light module of FIG. 12.

FIG. 14B is a side view of the circuit board of FIG. 14A.

FIG. 14C is a rear view of the circuit board of FIG. 14A.

FIG. 15 is a detail cutaway side view of the light module of FIG. 12.

FIG. 16A is a perspective view of a motorized gimbal connected to the camera assembly of FIG. 1 and to a head strap.

FIG. 16B is a second perspective view of the motorized gimbal, camera assembly and head strap of FIG. 16A.

FIG. 16C is a third perspective view of the motorized gimbal, camera assembly and head strap of FIG. 16A.

FIG. 17 is a flowchart describing a software process for aligning the field of view of the camera module of FIG. 1 with the line of sight of a user.

FIG. 18 is a flowchart describing a hardware process for aligning the field of view of the camera module of FIG. 1 with the line of sight of a user.

The use of the same reference symbols in different figures indicates similar or identical items.

### DETAILED DESCRIPTION

### System

Referring to FIG. 1, an exemplary camera assembly 2 is shown. The camera assembly 2 includes a head mount 4 configured to fit onto a user's head 6. The head mount 4 may include a strap 8 that may be adjustable by the user, in any suitable manner, to fit comfortably around his or her head. The head mount 4 optionally may include a top strap 10 that extends from one side of the strap 8, over the top of the user's head 6, to the other side of the strap 8. The top strap 10 assists in load-bearing, and may support a majority of the weight of the camera assembly 2 by contact with the top of the user's head 6. The top strap 10 may be adjustable by the user, in any suitable manner, to fit comfortably onto his or her head. The strap 8 and top strap 10 may be partially or completely elastic, or substantially inelastic. The strap 8 and top strap 10 may be fabricated from any suitable material. Referring also to FIG. 3, the camera assembly 2 may include speakers 46 and a microphone 48. As another example, referring also to FIG. 10, the speakers 46 and microphone 48 may be part of a standard headset 47. The headset 47 may use a wireless connection, such as one meeting the BLUETOOTH® (Bluetooth SIG, Kirkland, Wash.) standard, to connect to the wearable unit 50 as described below.

Referring also to FIG. 2, the camera assembly 2 includes a light module 20. The light module 20 may be attached to the head mount 4. The attachment between the light module 20 and the head mount 4 may be accomplished in any suitable manner. According to one embodiment, the light module 20 may be substantially fixed to the head mount 4. According to another embodiment, the light module 20 may be movable relative to the head mount 4, such as via a swivel joint or other connection allowing for movement of the light module 20 relative to the head mount 4. Where the light module 20 is movable relative to the head mount 4, the light module 20 may be lockable relative to the head mount 4 after the light module 20 has been moved to a desired position. The light module 20 is configured to emit light through an opening 22. The source of light from the light module may be one or more light-emitting diodes (LEDs), one or more laser diodes (LDs), one or more injection laser diodes (ILDs), one or more diode lasers, one or more xenon high-intensity discharge (HID) lamps, one or more halogen lamps, or any other suitable lighting source that is capable of being worn on a head mount 4 for the duration of a surgical procedure. Advantageously, the light module 20 produces light with a color rendering index (CRI) over 80; even more advantageously, the light module 20 produces light with a CRI over 90. A lens and/or diffuser may be positioned in, on or in proximity to the opening 22, if desired.

Referring also to FIGS. 2A-2B, the light module 20 may be configured to receive a swappable lens 130. In existing surgical lights or surgical lamps, a light shines onto a spot in the surgical field, and the diameter of that spot is adjusted using an iris through which light passes before it passes through a lens. Changing the diameter of the iris changes the amount of light that can pass through the iris, and thus through the lens, accordingly; decreasing the diameter of the iris reduces the amount of light that passes through the lens, and increasing the diameter of the iris increases the amount of light that passes through the lens. Thus, to tighten the spot diameter that is illuminated in the surgical field, the iris is tightened, and less light passes through the lens. The illuminance (lux) reaching the spot in the surgical field is equal to luminous flux (lumens) divided by area; the decrease in luminous flux from the reduction of the diameter of the iris is greater than the decrease in area of the spot diameter that is illuminated in the surgical field, such that the illuminance is decreased.

The use of swappable lenses 130 eliminates that problem with prior art surgical lighting. Different swappable lenses 130 may be utilized with the light module 20, where each swappable lens 130 is associated with a different fixed spot diameter in the surgical field. The lens element 131 of each swappable lens 130 may be glass, or may be fabricated from any other suitable material. The swappable lenses 130 may be threaded with threads 132 that are configured to be received by light module threads 134. According to other embodiments, the swappable lenses 130 may be detachably connected to the light module 20 in any other suitable manner and with any other suitable mechanism, such as by a quick disconnect. The swappable lenses 130 optionally include a grippable ring 134 defined at an end or another location thereon. The grippable ring 134 may be rubberized or treated in a manner to increase friction when grasped by a user, to allow for convenient unscrewing of a swappable lens 130 and screwing in of another swappable lens 130. When a user wishes to decrease the spot diameter illuminated in the surgical field, the user detaches the swappable lens 130 currently attached to the light module 20, and attaches a different swappable lens associated with that smaller spot diameter. No iris is utilized, and as a result, the amount of light passing through the swappable lens 130 is unchanged. Consequently, because the same amount of light passes through the swappable lens 130 to a smaller spot diameter, the illuminance of that spot diameter in the surgical field is increased.

Referring also to FIG. 3, the camera assembly 2 includes a camera module 30. According to some embodiments, the camera module 30 may be attached to the light module 20 The attachment between the light module 20 and the camera module 30 may be accomplished in any suitable manner. According to one embodiment, the light module 20 may be substantially fixed to the camera module 30. According to another embodiment, the camera module 30 may be movable relative to the light module 20, such as via a swivel joint or other connection allowing for movement of the camera module 30 relative to the light module 20. Where the camera module 30 is movable relative to the light module 20, the camera module 30 may be lockable relative to the light module 20 after the camera module 30 has been moved to a desired position.

According to other embodiments, the camera module 30 may be attached to the head mount 4. The attachment between the camera module 30 and the head mount 4 may be accomplished in any suitable manner. According to one embodiment, the camera module 30 may be substantially fixed to the head mount 4. According to another embodiment, the camera module 30 may be movable relative to the head mount 4, such as via a swivel joint or other connection allowing for movement of the camera module 30 relative to the head mount 4. Where the camera module 30 is movable relative to the head mount 4, the camera module 30 may be lockable relative to the head mount 4 after the camera module 30 has been moved to a desired position. In such embodiments, the light module 20 may be attached directly to the camera module 30 in a manner such as described above with regard to the connection of the camera module 30 directly to the light module 20.

According to other embodiments, the light module 20 and camera module 30 may be integrated into a single module.

As seen in FIG. 1, the light module 20 and camera module 30 are in close proximity to one another. In this way, the illumination provided by the light module 20 is generally aligned with the field of view of the camera module 30. Fixing the light module 20 and camera module 30 together may be advantageous, in that the alignment of the light module 20 and the camera module 30 may be preset and maintained at the preset. Allowing the camera module 30 to be moved relative to the light module 20 allows the user to change the alignment as desired.

Referring also to FIGS. 2-3, according to some embodiments, the camera module 30 includes a liquid lens 32. Like traditional optical lenses made from glass, a liquid lens 32 is a single optical element that includes an optical liquid material that can change its shape. The focal length of the liquid lens 32 is changed by controlling the radius of curvature and/or the index of refraction of the optical liquid material. This change in radius is electronically controlled, and rapidly changes on the order of milliseconds. Technologies ranging from electrowetting to shape changing polymers to acousto-optic tuning may be used to control the radius of curvature and index of refraction of the liquid lens 32; any suitable method may be used to focus the liquid lens 32.

An image sensor 34 is placed in the camera relative to the liquid lens 32 to collect light from the liquid lens 32. Optionally, one or more intermediate lenses (not shown) may be placed in the optical path between the liquid lens 32 and the image sensor 34 in a multi-element structure. The image sensor 34 may be a high resolution sensor, configured to output video in 4K, 8K or other high resolution format.

According to some embodiments, the camera module 30 includes a time-of-flight sensor 36 in proximity to the liquid lens 32. According to some embodiments, the time-of-flight sensor 36 emits intermittent pulses of light, which may be generated by an LED, a laser, or any other suitable source. The time between pulses of light may be regular, or may be irregular and linked to motion of the camera module 30. The light emitted by the time-of-flight sensor 36 may be in the infrared range of wavelengths, according to some embodiments; according to other embodiments, the light emitted by the time-of-flight sensor 36 may be in a different range of wavelengths. The light emitted by the time-of-flight sensor 36 is reflected by objects in the field of view of the camera module 30, and a portion of that reflected light is received by the time-of-flight sensor 36. The time between emission of the light pulse by the time-of-flight sensor 36 and the sensing by the time-of-flight sensor 36 of light reflected from that light pulse by an objects illuminated by the time-of-flight sensor 36 allows the distance between the time-of-flight sensor 36 and those objects to be calculated.

According to other embodiments, the time-of-flight sensor 36 emits light continuously. The amplitude of the emitted light is modulated, creating a light source of a sinusoidal form at a known and controlled frequency. The reflected light is phase-shifted, and the time-of-flight sensor 36 determines the phase shift of the reflected light to calculate the distance between the time-of-flight sensor 36 and objects illuminated by the time-of-flight sensor 36.

According to other embodiments, the time-of-flight sensor 36 may be a lidar device. Regardless of which embodiment of the time-of-flight sensor 36 is utilized, the time-of-flight sensor 36 provides fast and precise measurements of the distance between the time-of-flight sensor 36 and the objects illuminated thereby—in surgical applications, for example, those objects are structures in a patient's body within the surgical field. The use of a time-of-flight sensor 36 in conjunction with a liquid lens 32 in the camera module 30 allows for very fast and accurate focusing on the area of the surgical field where the user is looking. The focusing provided by the combination of the time-of-flights sensor 36 and the liquid lens 32 may be continuous or near-continuous, maintaining the image of the objects in the field of view of the image sensor 34 in focus or very close to focus. Data from the time-of-flight sensor 36 may be routed through a microcontroller 33 and then transmitted to the liquid lens 32. According to some embodiments, the microcontroller 33 may process the range data received from the time-of-flight sensor 36 and then transmit focusing instructions directly to the liquid lens 32. According to other embodiments, one or more other components of the camera system 2 may perform such processing.

According to some embodiments, the camera module 30 may include an inertial sensor 38. The inertial sensor 38 may include one or more accelerometers. Advantageously, the inertial sensor 38 includes accelerometers that measure acceleration along each of three orthogonal axes. The inertial sensor 38 may include one or more gyroscopes, such as but not limited to MEMS gyroscopes. Advantageously, the inertial sensor 38 includes gyroscopes that measure rotation about each of three orthogonal axes.

According to some embodiments, the camera module 30 includes an image signal processor 40. The image signal processor 40 receives image data from the image sensor 34, the time-of-flight sensor 36, and the inertial sensor 38. Data from the inertial sensor 38 may be routed through a serializer/deserializer 42 (described in greater detail below) outside of the camera module 30, and then transmitted back to the image signal processor 40. Alternately, data from the inertial sensor 38 is transmitted directly from the inertial sensor to the image signal processor 40, without leaving the camera module 30. Alternately, data from the inertial sensor 38 may be routed in any other suitable manner that causes that data to reach the image signal processor 40.

The image signal processor 40 utilizes the information provided by the time-of-flight sensor 36 and the inertial sensor 38 to modify the data received from the image sensor 34 in order to reduce or eliminate shakiness in the image data received from the image sensor 34. Motion sickness can be experienced by a person who views a moving image on a screen. The more that a moving image is unstable, the greater the potential that a viewer may experience motion sickness upon viewing that moving image. Such motion sickness can result in nausea and vomiting, both of which are undesirable in a surgical setting. By integrating data from the image sensor 34, the time-of-flight sensor 36, and the inertial sensor 38 to reduce or eliminate shakiness in the moving images captured by the image sensor 34, the potential for motion sickness by a viewer is reduced or eliminated, and the image quality is enhanced. In addition, the continuous or near-continuous focusing provided by the combination of the time-of-flight sensor 36 and the liquid lens 32 causes the video experienced by a viewer to be in focus or close to in focus, further reducing the potential for a motion sickness effect that could be experienced by a viewer. The use of the liquid lens 32, the time-of-flight sensor 36, and the inertial sensor 38 in combination synergistically improves video stability and watchability.

The image signal processor 40 may output data to a serializer/deserializer 42, which may be located in the camera module 30. The serializer/deserializer 42 transmits data to and receives data from a wearable unit 50. According to some embodiments, the serializer/deserializer 42 is connected to the wearable unit 50 via a Gigabit Multimedia Serial Link (GMSL) (Maxim Integrated Products, San Jose, Calif.) cable 43 and associated connectors. One GMSL connector may be provided in association with the camera module 30, and another GMSL connector may be provided in association with the wearable unit 50. The GMSL standard provides multistream support over a single cable, reducing the number of cables in the camera system 120. Further, the GMSL standard allows aggregation of different protocols in a single connection, while meeting hospital requirements or other locations' requirements for electromagnetic interference. According to other embodiments, the serializer/deserializer 42 is connected to the wearable unit 50 via a coax cable 44 or other cable, or wirelessly, and/or using a suitable standard other than GMSL.

The serializer/deserializer 42 may receive from the image signal processor 40 data that includes image data (such as in raw or Bayer format), inertial data from the inertia sensor 38, and/or time-of-flight data from the time-of-flight sensor 36, and then serialize that data for transmission to the wearable unit 50. The serializer/deserializer 42 may receive from the wearable unit 50 control data for the liquid lens 32 to adjust the liquid lens 32 for calibration or manual adjustments (without time of flight focus), firmware updates for the processors and sensors associated with the camera module 30, and/or other data.

According to other embodiments, the image signal processor 40 is located elsewhere than the camera module 30. In such embodiments, image data from the image sensor 34, the time-of-flight sensor 36, and the inertial sensor 38 are transmitted to the image signal processor 40 in any suitable wired or wireless manner. The components of the wearable unit 50 may be distributed across two or more separate housings on the user, for balance or other considerations. One or more processors in the wearable unit 50 may be distributed across two or more separate housings on the user, for balance or other considerations. Further, components described in this document as being located in the camera module 30 may instead be located in the wearable unit 50, and vice versa.

Referring also to FIGS. 4-6B, an exemplary camera system 120 includes the camera assembly 2, and one or more additional body-mounted components. The body-mounted components advantageously are arranged ergonomically, to minimize and to balance the weight on the user's head 6, and to place heavier components closer to the user's waist. The serializer/deserializer 42 may be located in wearable unit 50. The wearable unit 50 may be configured to be carried at the back of the user's neck by the shoulders, or at another location on the back. As another example, the wearable unit 50 may be positioned on the user's chest, a user's side, a user's waist, on an arm or leg, or at any other position on the user's body. The wearable unit 50 may be secured to the user in any suitable manner and with any suitable structure or mechanism. According to some embodiments, the wearable unit 50 may be attached to one or more straps, which the user may wear on his or her shoulders, to carry the wearable unit 50 below the user's neck on his or her back. Alternately, if the wearable unit 50 is relatively light, the wearable unit 50 may hang from and be supported by the rear of the strap 8. The strap 8 may include one or more wire guides 9 that hold one or more wires 124 that carry data to and/or from the camera module 30, and that carry power to the light module 20 and camera module 30.

A battery 60 may be worn by the user. The battery 60 may be worn anywhere on the user's body and may be secured to the user's body in any suitable manner. According to some embodiments, the battery 60 may be most conveniently and comfortably placed about the user's waist or hips using a belt 126. According to other embodiments, the battery 60 may take the form of a backpack or other ergonomically-desirable configuration. Advantageously, the battery 60 is rechargeable, and easily detachable from the associated belt or other support that carries the battery 60. In this way, the battery 60 can be replaced quickly and easily with a fully-charged one if the battery 60 becomes depleted during a surgical procedure. According to other embodiments, the battery 60 is not rechargeable, or is integrated into and not detachable from the associated belt or other support.

The battery 60 is connected to one or more of the light module 20, the camera module 30 and the wearable unit 50, in order to supply power thereto. According to some embodiments, the battery 60 may be connected to one or more of the light module 20, the camera module 30 and the wearable unit 50 with separate, individual cables, in order to power one or more such components independently. According to other embodiments, the battery 60 may be connected directly to only one of the light module 20, the camera module 30 and the wearable unit 50, and the other modules are electrically connected to the module which receives power from the battery 60. In this way, the number of power cables required by the camera system 120 may be reduced. As one example, the wearable unit 50 receives power from the battery 60, and then distributes power to the light module 20, camera module 30, and any other components of the camera system 120.

Referring also to FIG. 7, the wearable unit 50 has a data connection with a base station 70. The data connection between the wearable unit 50 and the base station 70 may be accomplished wirelessly, such as via Wi-Fi. In this way, the user of the camera assembly 2 has greater freedom of motion and does not need to worry about becoming tangled in cable. Alternately, the data connection between the wearable unit 50 and the base station 70 may be accomplished via a cable 72, such as a coax cable. The data connection between the wearable unit 50 and the base station 70 may be controlled by the main processor 51, which may control the flow of data to and/or from the base station 70, as well as to and/or from the camera module 30, light module 20, and/or other head-mounted components of the camera system 120.

The base station 70 may include one or more ports for coax, HDMI, Ethernet, or other connections. Those ports may be used to receive data from other cameras or sensors, and transmit data to a network, to one or more monitors, or other locations. Multiple individuals in proximity to the subject of the video may wear a camera assembly 2, and the data output from each camera assembly may be transmitted to the same base station 70, in the same manner as described above.

Optionally, referring also to FIGS. 8-9, where the user is a surgeon, a camera 92 may be attached to one or more surgical tools 90 used by a surgeon in order to improve accuracy in the use of that tool. Very small cameras are known. As one example, the Omnivision OV6948 camera (Omni Vision Technologies, Inc.; Santa Clara, Calif.) is only 0.575×0.575×0.232 mm in size. Such tiny cameras are inexpensive enough that it can be incorporated into a single-use medical device, obviating the need for sterilization between procedures. Additionally, by attaching a camera to one or more surgical tools for open surgery, the need for a separate endoscope or other relatively-bulky camera (and its support equipment) may be eliminated, reducing costs and reducing the amount of equipment needed in the operating room. A camera 92 may be attached to any surgical tool 90. For example, FIGS. 8-9 show a camera 92 attached to a standard aortic cutter 92. The inclusion of a camera 92 on the aortic cutter 90 allows the user a better view of the tissue to be treated, but also may allow the user to inspect the hole made by the aortic cutter 90 in tissue to determine whether that hole includes nicks or other abnormalities that may affect a later part of a surgical procedure. This ability to inspect closely the result of use of any surgical tool provides additional assurance that the intended procedure was performed as intended and as expected. Data from the camera 92 is transmitted to the wearable unit 50 in the same manner or a similar manner as described above with regard to the camera module 30. A cable 94 may transmit data from the camera 92 to the wearable unit 50. According to other embodiments, the camera 92 transmits data wirelessly to the wearable unit 50. According to other embodiments, data from the camera 92 is transmitted directly to the base station 70. According to other embodiments, a camera 92 may be attached to something other than a surgical tool 90. For example, a camera 92 may be attached to a tool or device used by an EMT or paramedic at an accident scene.

According to other embodiments, any camera that is useful for recording the particular subject of the video may be connected directly or indirectly to the base station 70, and may be recorded and utilized like any other input to the base station 70. As one example, a camera 92 may be mounted to the helmet of a bicyclist, motorcyclist or skier. As another example, a camera 92 may be included in, or provided as, glasses or sunglasses wearable by the user, such as the RAY-BAN® STORIES® smart glasses of Luxottica USA LLC S.p.A. of Milan, Italy. As another example, a camera 92 may be positioned in an ambulance to view a patient during transport. As another example, a camera 92 may be positioned in a hospital room, treatment room and/or diagnosis room. As another example, the camera 91 may be a standard body-mounted camera worn by an EMT, paramedic, firefighter or law enforcement officer.

Referring also to FIGS. 6, 6A, 6B, and 10-11, a tablet 80 or other device may be used to control how and where the data is output from the base station 70. The tablet 80 may be connected to the base station 70 wirelessly, such as through a Wi-Fi connection, or may be connected to the base station 70 by a cable, such as a coax or HDMI cable. The base station 70 may be located in an operating room. However, the base station 70 and other components described in this document may be used in any other suitable location.

### Second Exemplary Light Module

Referring also to FIG. 12, another exemplary light module 220 is shown. The light module 220 may be connected to the camera module 30 directly, as seen in FIG. 1, or may be separate from the camera module 30 and attached to the strap 8 separately from the camera module 30.

Referring also to FIGS. 13A-13C, a heat sink 230 may be enclosed within an outer shell 232 of the light module 220. The exterior of the heat sink 230 includes a plurality of fins 234 extending therefrom. One or more of the fins 234 may be generally circular. One or more of the fins 234 may be generally arcuate. Two or more of the fins 234 may be spaced longitudinally at substantially the same distance apart from one another. The heat sink 230 may be metallic, or may be fabricated from any other suitable material. The heat sink 230 may be fabricated from a single piece of metal, such as by machining. Alternately, the heat sink 230 may be fabricated in any other suitable manner, such as by metal injection molding (MIM), additive manufacturing, and/or welding one or more fins 234 to a core of the heat sink 230.

Referring also to FIG. 15, a slot 236 may extend through the bottom of the heat sink 236. The slot 236 may be rectangular in order to receive a rectangular printed circuit board or other insert, or may have any other shape in order to receive a printed circuit board or other insert of any corresponding shape. Referring also to FIGS. 14A-14C, an LED assembly 270 is shown. The LED assembly 270 may include a first printed circuit board 272 and a second printed circuit board 274 extending substantially orthogonal to the first printed circuit board 272. The first printed circuit board 274 may be configured to receive power via the power input 238 of the light module 220. Additionally, or instead, the first printed circuit board 274 may include a driver to manage power provided to an LED. Other control circuitry, processor(s), memory, and/or related components may be associated with the first printed circuit board 274 as needed. The second printed circuit board 274 may be an LED module electrically connected to the first printed circuit board 272; an LED module is a printed circuit board with one or more LED packages 276 attached thereto. Alternately, the second printed circuit board 274 may be a different structure with LED packages 276 attached thereto. By definition, the LED packages 276 each include an LED chip that emits light. The LED packages 276 may be electrically connected to and controlled by the first printed circuit board 272. Referring also to FIG. 12, the LED assembly 270 may be located in the light module 220 such that the first printed circuit board 272 is fit between the outer surface of the heat sink 232 and the inner surface of the outer shell 232. The second printed circuit board 274 extends upward from the first printed circuit board 272 into the slot 236 defined through the bottom of the heat sink 232. The distal surface of the slot 236 may be substantially planar, and the second printed circuit board 274 thus is easily slidable into the slot 236 during assembly and after maintenance. For transmission and/or receipt of data, the LED assembly 270 may be connected to the wearable unit 50 via a cable such as a GMSL cable. Alternately, the LED assembly 270 may be connected to the serializer/deserializer 42, which in turn is connected to the GMSL cable 43 extending to the wearable unit 50.

Referring also to FIG. 13A, it can be seen that the second printed circuit board 274 is received into the slot 236 in the heat sink 232 such that LED packages 276 are both exposed to the open cavity 240 within the distal end of the heat sink 232. Referring also to FIGS. 12 and 15, at least the proximal end of the open cavity 240 is shaped generally parabolically. The surface of the open cavity 240 advantageously is reflective or polished. For example, where the heat sink 232 is fabricated from steel, the surface of the open cavity 240 may be polished steel. The surface of the open cavity 240 may be coated with a reflective coating to increase the efficiency of light output therefrom. A lens 242 may be positioned at the proximal end of the open cavity 240. As one example, a lens holder 244 may be an annular structure that is positioned at the proximal end of the open cavity 240. The lens holder 244 may be welded to or otherwise affixed to the heat sink 232, or may be fabricated integrally with the heat sink 232. The lens 242, in turn, may be affixed to the lens holder 244, such as by adhesive. The lens 242 may be fabricated from glass, plastic or any other suitable material. The lens 242 may be attached to the second printed circuit board 274 or fabricated as a part of the second printed circuit board 274. The open cavity 240 and the lens 242 may be shaped to focus light from the LED packages 276 onto the swappable lens 130.

The distal end of the heat sink 230 may be threaded or otherwise configured to receive a swappable lens 130, as described above. According to other embodiments, the distal end of the outer shell 232, or a structure in proximity to the distal end of the outer shell 232, is threaded or otherwise configured to receive a swappable lens 130. According to other embodiments, the lens 130 is fixed to the heat sink 230 or other component of the light module 220, and is not swappable.

A fan 260 may be mounted in the light module 220 above the heat sink 230. The fan 260 may be configured to pull air into the light module 220 or pull air out of the light module 220. In either case, referring also to FIG. 2, holes or vents 262 in the outer shell 232 allow for the flow of cooler air into the outer shell 232 and across the fins 234 of the heat sink 230 to provide cooling of the heat sink 230.

Referring also to FIGS. 16AC, the camera module 30 optionally may be connected to a motorized gimbal 400. The motorized gimbal 400 may be connected to the strap 8. According to other embodiments, the motorized gimbal may be connected to any other suitable base associated with the camera module 30. The motorized gimbal 400 may be configured to pan and tilt the camera module 30. The motorized gimbal 400 may include a pan motor therewithin that is controllable to cause a rotation about the pan post 402 of the motorized gimbal 400. The motorized gimbal 400 also, or instead, may include a tilt motor therewithin that is controllable to cause a rotation about the tilt post 404 of the motorized gimbal 400. The pan motor and tilt motor may be individually controllable by the application of power to each individual motor. In this way, the pan motor may be controllable to move a particular amount by software, such that software controls the amount of pan by the duration of power applied to the pan motor. Similarly, the tilt motor may be controllable to move a particular amount by software, such that software controls the amount of tilt by the duration of power applied to the tilt motor. The direction of motion of pan and/or tilt may be controlled by, for example, changing the polarity of DC power transmitted to the pan motor and/or tilt motor. Alternately, data is transmitted to the pan motor and/or tilt motor commanding the pan motor and/or tilt motor to rotate in a particular direction upon the application of electric power thereto. Wires 124, described above, may provide power to the motorized gimbal 400, and/or transmit data such as rotational position data from the motorized gimbal 400.

For transmission and/or receipt of data and/or for the receipt of commands, the motorized camera module gimbal 400 may be connected to the wearable unit 50 via a cable such as the GMSL cable 43. Alternately, motorized camera module gimbal 400 may be connected to the serializer/deserializer 42, which in turn is connected to the GMSL cable 43 extending to the wearable unit 50. Data transmitted to the motorized gimbal 400 from the wearable unit 50 may include commands directed to the direction and amount of rotation of the pan motor and/or tilt motor. Data transmitted from the motorized gimbal 400 to the wearable unit 50 may include current rotational position data and/or other state data of the pan motor and/or tilt motor.

### Operation

In use, one or more users put on one or more components of the camera system 120 as described above, in particular the camera assembly 2 that is worn on the user's head. Where the camera system 120 is used in an operating room, for example, each user may be any healthcare professional who is authorized to be in proximity to a patient, such as but not limited to a physician, nurse, medtech, EMT, paramedic, orderly, or vendor representative. The more users, the greater the flexibility of the camera system 120 and the greater the ability to switch between different views.

Where the camera system 120 is utilized for healthcare, it may be used in locations such as operating rooms, catheterization labs, treatment rooms, diagnosis rooms, emergency rooms, accident sites, and locations outside of a hospital or healthcare building. An example of the use of the camera system 120 for surgery in an operating room is described below, but this example does not limit the use of the camera system 120 or the environment in which the camera system 120 may be used. During surgery, the patient 200 may be positioned on an operating table 102 in the operating room. One or more monitors 104 may be positioned in the operating room 100, whether mounted permanently to a wall or other structure, or placed on stands that may be moved. One or more monitors 104 may be placed in a location outside the operating room 100, which may be adjacent to the operating room 100, may be in the same building and spaced apart from the operating room 100, or may be in a different building from the operating room 100. The base station 70 transmits video from the camera module 30 to one or more monitors 104. A user may utilize the tablet 80 to control video transmission from the base station 70 to the one or more monitors 104. As one example, the same video transmission may be sent to every monitor 104. As another example, at least one monitor 104 receives a different video transmission from the base station 70 than at least one other monitor 104. In this way, different views of the open surgery may be shown on different monitors 104. As one example, a surgeon and an attending nurse each may wear a camera assembly 2, and a camera 92 may be attached to a surgical tool 90 used in the procedure. In this example, three separate video streams are generated, and are received by the base station 70; each of those video streams may be shown at the same time on different monitors 104. Alternately, one or two of the three video streams may be shown on one or more different monitors 104, omitting one or two of the video streams. The tablet 80 and its user may be located in the operating room 100, or in a remote location, as long as the tablet 80 has a data connection to the base station 70. According to some embodiments, the base station 70 may be configured to livestream video and audio 71 via the internet or other communications network to remotely-located viewers. In this way, interested people, such as medical students or physicians, can view the procedure as the physician performs it. The livestream 71 may be one-way, in which viewers can view the livestream 71 but not interact with it, or two-way, in which one or more viewers can transmit audio and/or video themselves back to the base station 70. Two-way livestreaming 71 may be useful where specialist knowledge of a remotely-located physician would be useful, such that the remotely-located physician can provide helpful information to the physician performing the procedure. In accordance with some embodiments, all video and audio is livestreamed 71 from the base station 70, and the monitor or monitors 104 receive and show a livestream 71 received from the base station 70.

The user or users wearing one or more components of the camera system 120 acquire video of a subject with at least one head-mounted camera assembly 2. Where the camera system is used in an operating room 100, for example, that video may be acquired by directly viewing the surgical field during open surgery. Where the procedure includes an endoscopic or percutaneous component, that video may be acquired from viewing the control and/or display elements associated with the endoscopic or percutaneous component of the procedure. In this way, the viewer of the video from the camera system 120 can obtain greater knowledge of the overall procedure, which may be useful from an instructional standpoint and also from the standpoint of retaining a record of the particular procedure performed on that particular patient. The user or users of the camera system 120 look wherever he, she or they would look to perform the procedure in the absence of the camera system 120. It is up to the user of the tablet 80 to select and control the video stream or streams that are output to the monitor or monitors 104 and/or livestreamed 71 outward by the base station.

Video acquired by each user's head-mounted camera assembly 2 may be stabilized by the image signal processor 40 associated with that head-mounted camera assembly 2. Then, that stabilized video is transmitted to and received by the base station 70. Another user, who may or may not be wearing one or more components of the camera system 120, controls the video output from the base station 70, such as via a tablet 80, as described above. The video output may be controlled to appear on one or more monitors 104 inside and/or outside a room, may be controlled to stream to recipients outside the room, and/or may be controlled to be saved locally or remotely.

According to some embodiments, one or more of the video streams received by the base station 70 are saved for later viewing. Such one or more video streams may be saved at the base station 70 itself, and/or on removable media associated with the base station 70. According to some embodiments, all video streams received by the base station 70 are stored. In some embodiments, a user may make that saved video available to others, such as via social media. The storage of video in a manner that can be viewed by others on demand is referred to in this document as “sharing” video. In some embodiments, in which the camera system is used in a hospital operating room 100, a record of the surgical procedure thus may be saved by the hospital, the surgeon, and/or others for legal, regulatory and/or compliance purposes. The saved video streams may be saved in a system that allows for access by other doctors, medical students, or the public, for learning and educational purposes. Such video storage and sharing may be particularly useful for medical students at a time such as during the COVID-19 pandemic, in which in-person learning may be limited or suspended altogether.

While certain examples above describes the use of a camera system 120 in an operating room, a user may utilize the camera system 120 in any other suitable location and for any other suitable purpose. Regardless of the particular location, the camera system 120 functions substantially as described above. For example, the camera system 120 may be used in a hospital room, a treatment room, a field hospital, an emergency room, in the field at an accident site, in a veterinary hospital, or any other suitable location. As another example, the camera system 120 may be used by scientists at a site of exploration in order to transmit detailed video to viewers who may be located a significant distance away. As another example, the camera system 120 may be used by one or more mechanics in the course of diagnosing and repairing damaged vehicles in or out of a garage, whether to create videos useful for training other mechanics, for obtaining expert advice from other mechanics at a distant location, or other reasons.

As another example, the camera system 120 may be utilized by an EMT or paramedic at an accident site. The base station 70 may be located in an ambulance, and may be capable of transmitting video and other data via any suitable communication technology, such as cellular network data service. When used by an EMT or paramedic at an accident site or other site where emergency treatment of a patient is necessary, two-way livestreaming 71 may be useful, because such two-way livestreaming would allow a remotely-located doctor to provide instructions to the EMT or paramedic based on the content of the livestream 71.

### Software Alignment of Camera Field of View

According to some embodiments, software may be utilized to align the field of view of the camera module 30 with the user's ocular line of sight. The software may reside in the wearable unit 50, in the camera module 30, and/or elsewhere. Referring to FIG. 17, the software may operate according to an exemplary process 500. At box 502, the microphone 48 detects a voice command for voice activation of detection of a gesture. The voice command may be a word or phrase that is preset by the manufacturer, or may be a word or phrase that may be set by the user. By way of example and not limitation, the word may be “field” or the phrase may be “field of view”. According to some embodiments, the microphone 48 listens constantly, or effectively constantly at very short intervals, for the voice activation command. According to other embodiments, the microphone 48 does not listen constantly, but is triggered to listen by a button or other mechanism or input that signals the process 500 that the user is ready to give a voice command. The user, an assistant to the user, or in surgical applications, a nurse or other professional in the operating room may press the button or otherwise provide input to the process 500. According to other embodiments, instead of voice activation in box 502, the user presses a button or provides other input to the process 500 for activation of detection of a gesture. Such embodiments that involve pressing a button or other physical input may be particularly useful, as well as cost-effective, for non-surgical use of the process where there is no sterile field to maintain.

At box 504, the user provides gestural input to the process 500. The gestural input may be drawing a virtual shape in the air by a fingertip or fingertips of the user around an area of interest. The virtual shape may be a general circle, where the field of view may be generally encompassed by the generally circular shape. The terms “general circle” and “generally circular” refer to the fact that no user can gesture a geometrically perfect circle, and that it is unlikely the gestured circle is a completely closed geometrically perfect circle.

According to other embodiments, instead of voice activation at box 502, the process 500 checks input from the camera module 30 and/or other sensor constantly, or effectively constantly at very short intervals, for the gestural command Such embodiments may be more power-intensive and/or more computationally intensive, but may provide additional utility for the user in certain applications where voice activation is difficult, such as applications in noisy areas or in areas where quiet is particularly important

The process moves to box 506, at which the camera module 30 registers and recognizes the movement of the user's hand and records that movement. Put another way, the process recognizes the gestural input of box 504 by utilizing the camera module 30 to detect that input. Gesture recognition may be performed with custom or customized software, or with off-the-shelf software, such as the Motion Gestures software of Motion Gestures, Kitchener, Ontario, Canada; the TouchFree software of Ultraleap, Mountain View, Calif., or other off-the-shelf software.

The process moves to box 508, where the software translates the movement of the user's hand that was recognized in box 506 into a vector-based graph having X and Y coordinates. That is, the shape of the virtual general circle, or other shape, made by the user in box 504 is converted into a mathematical and/or graphical form that can be further analyzed mathematically. Alternately, the software may translate the movement of the user's hand that was recognized in box 506 into any other type of graph that is usable in subsequent boxes. Next, in box 510, the software determines the center of the general circle or other shape that was generated in box 508. The center need not be the precise center of the general circle or other shape, such that an approximation of the center point is sufficient. Analysis of the vector-based graph of the shape, in X and Y coordinates, provides that actual or approximate center point.

Next, in box 512, the image from the camera module is zoomed into, such that the outer boundaries of the visual area are substantially aligned with the boundaries of the vector graph. As described above, the camera module 30 includes an image sensor 34 that is a high-resolution sensor capable of 4K, 8K or higher image resolution. Because the resolution of the image sensor 34 is so high, the alignment of the field of view of the camera module 30 with the user's field of view is performed in software by zooming into the area generally encompassed by, or otherwise associated with, the gesture sensed in diamond 504. Where that gesture is generally a circle, as described above, such zooming is performed to generally encompass the area within the gestured circle. The camera module 30 itself performs no zooming; rather, the high-resolution output of the camera module 30 remains the same, and that output is zoomed into in software. After the zooming, the image is panned and tilted in software so that the center of the zoomed-into area is aligned with the center of the vector graph circle or other vector graph shape. The process 500 is then complete for that particular field-of -view alignment. If the user wishes to change the field of view, the process 500 begins again at box 502.

### Hardware Alignment of Camera Field of View

According to some embodiments, hardware may be utilized in combination with software to align the field of view of the camera module 30 with the user's ocular line of sight. As described above, the software may reside in the wearable unit 50, in the camera module 30, and/or elsewhere. Referring to FIG. 18, the software may operate according to an exemplary process 600. For economy of description, it is noted that box 602 is substantially the same as box 502 described above; box 604 is substantially the same as box 504 described above; box 606 is substantially the same as box 506 described above; box 608 is substantially the same as box 508 described above, and box 610 is substantially the same as box 510 described above.

After box 610, the process moves to box 612. At box 612, the software commands the camera module 30 to zoom optically until the outer boundaries of the visual area are substantially aligned with the boundaries of the vector graph. The alignment of the field of view of the camera module 30 with the user's field of view is performed in hardware by zooming optically into the area generally encompassed by, or otherwise associated with, the gesture sensed in diamond 504. Where that gesture is generally a circle, as described above, such zooming is performed to generally encompass the area within the gestured circle. Optical zooming is performed by physically moving one or more lenses using a motor. Such physical motion of components of the camera module 30 is part of the hardware alignment of the camera field of view. Alternately, the zooming performed in box 612 may be performed in software, as described above, such that the high-resolution output of the camera module 30 remains the same, and that output is zoomed into in software.

After the zooming of box 612, in box 614 the image is panned and tilted so that the center of the zoomed-into area is aligned with the center of the vector graph circle or other vector graph shape. The software transmits one or more commands to one or more motors within the camera gimbal 400 to cause the camera module 30 to pan and/or tilt as required to have the center of the zoomed area align with the center of the vector circle. Such commands cause the motors of the camera gimbal 400 to pan and/or tilt the camera module 30 physically so that the center of the zoomed area aligns with the center of the vector circle. That is, in box 614, the panning and/or tilting are performed mechanically by commanding the camera gimbal 400 to physically move the camera module 30.

The process 500 is then complete for that particular field-of -view alignment. If the user wishes to change the field of view, the process 500 begins again at box 502.

### Alignment of Camera Field of View with Head-Mounted Light

According to some embodiments, the camera module 30 may be utilized in conjunction with a light module 20, 220. Rather than utilizing gestural sensing, the software may sense the edges of the light emitted from the light module 20, 220 onto an area, such as but not limited to a patient in an operating room. The light module 20, 220 emits a strong light, so that the difference in brightness between the illuminated area and the non-illuminated area is strong and well-defined.

In such embodiments, the process 500 or the process 600 described above generally applies, depending on whether the camera field of view is to be aligned in software alone or with hardware, respectively, but with the following variations. Boxes 504, 604 are not utilized. In boxes 506, 606 , the edges of the area illuminated by the light module 20, 220 are sensed, instead of a gesture made by the user. In boxes 508, 608 the software translates the shape of the illuminated area to a vector-based graph with X and Y coordinates. In boxes 510, 610, software determines the center of the vector circle corresponding to the illuminated area. Where the alignment of the camera field of view is performed in software, the process 500 continues to box 512. Where the alignment of the camera field of view is performed with hardware, the process 600 continues to box 612.

As used in this document, and as customarily used in the art, terms of approximation, including the words “substantially” and “about,” are defined to mean normal variations in the dimensions and other properties of finished goods that result from manufacturing tolerances and other manufacturing imprecisions, the normal variations in the measurement of such dimensions and other properties of finished goods, and normal tolerances and deviations experienced within a process of use.

While the invention has been described in detail, it will be apparent to one skilled in the art that various changes and modifications can be made and equivalents employed, without departing from the present invention. It is to be understood that the invention is not limited to the details of construction, the arrangements of components, and/or the method set forth in the above description or illustrated in the drawings. Statements in the abstract of this document, and any summary statements in this document, are merely exemplary; they are not, and cannot be interpreted as, limiting the scope of the claims. Further, the figures are merely exemplary and not limiting. Topical headings and subheadings are for the convenience of the reader only. They should not and cannot be construed to have any substantive significance, meaning or interpretation, and should not and cannot be deemed to indicate that all of the information relating to any particular topic is to be found under or limited to any particular heading or subheading. Therefore, the invention is not to be restricted or limited except in accordance with the following claims and their legal equivalents.

What is claimed is:

1. A method for aligning the field of view of a user with the field of view of a camera mounted on the user's head, comprising:
providing at least one head-mounted camera module, said camera module including at least one sensor, said at least one sensor including an image sensor, wherein said image sensor outputs video of an area;
receiving a first input from a user to expect a second input relating to the field of view;
receiving said second input relating to the field of view; and
aligning the field of view of the user with the field of view of the camera.

2. The method of claim 1, wherein at least one said at least one sensor is an image sensor in said camera module.

3. The method of claim 1, wherein said first input is a voice command.

4. The method of claim 1, wherein said second input is gestural input from the user.

5. The method of claim 4, wherein said gestural input is a generally circular motion of the user's fingertips.

6. The method of claim 5, further comprising translating said generally circular motion of the user's fingertips into a vector-based graph having X and Y coordinates.

7. The method of claim 6, further comprising determining the general center of said vector-based graph using said X and Y coordinates.

8. The method of claim 7, wherein said aligning is performed to said general center of said vector-based graph.

9. The method of claim 1, wherein said aligning includes zooming in to an area of said video output from said image sensor.

10. The method of claim 1, further comprising providing at least one light module associated with said camera module; wherein said at least one light module illuminates a light field on the patient;
wherein said second input from at least one sensor comprises an edge of said light field;
determining that the field of view of the user is substantially the same as said light field; and
aligning the field of view of the user with the field of view of the camera.

11. The method of claim 10, wherein said aligning includes zooming in to an area of said video output from said image sensor.

12. The method of claim 11, wherein said zooming is performed to a portion of said area generally enclosed by said light field.

13. The method of claim 10, wherein said aligning further includes panning and tilting said area of said video output from said image sensor.

14. A method for aligning the field of view of a user with the field of view of a camera mounted on the user's head, comprising:
providing at least one head-mounted camera module, said camera module including at least one sensor, said at least one sensor including an image sensor, wherein said image sensor outputs video of an area; and at least one motorized gimbal attached to said camera module;
receiving a first input from a user to expect a second input relating to the field of view;
receiving said second input relating to the field of view; and
aligning the field of view of the user with the field of view of the camera.

15. The method of claim 14, wherein said aligning is performed by transmitting at least one command to said motorized gimbal to move said camera module.

16. The method of claim 15, wherein at least one said command causes said motorized gimbal to pan said camera module.

17. The method of claim 15, wherein at least one said command causes said motorized gimbal to tilt said camera module.

18. The method of claim 14, wherein said aligning includes transmitting at least one command to said camera module to optically zoom in.

19. A camera system mountable on the head of a user, comprising:
at least one head-mounted light module;
a camera module associated with said light module;
a motorized camera module gimbal attached to said camera module; and
a base to which said motorized camera module gimbal is attached.

20. The camera system of claim 19, wherein said base is one of the group consisting of: said light module, a strap configured for attachment to a user's head, and a shoulder mount.
